(19) United States
(12) Patent Application Publication
(10) Pub. No.: US 2025/0247522 A1
(43) Pub. Date: Jul. 31, 2025

(54) MERGE CANDIDATE DERIVATION IMPROVEMENT BY USING INTRA TEMPLATE-MATCHING

(71) Applicant: Tencent America LLC, Palo Alto, CA (US)

(72) Inventors: Lien-Fei CHEN, Palo Alto, CA (US); Yonguk Yoon, Palo Alto, CA (US); Biao Wang, Palo Alto, CA (US); Roman Chernyak, Palo Alto, CA (US); Shan Liu, Palo Alto, CA (US); Motong Xu, Palo Alto, CA (US); Ziyue Xiang, Palo Alto, CA (US)

(21) Appl. No.: 19/039,629

(22) Filed: Jan. 28, 2025

Related U.S. Application Data
(60) Provisional application No. 63/627,685, filed on Jan. 31, 2024.

(51) Int. Cl. H04N 19/105; H04N 19/167; H04N 19/176; H04N 19/513

(52) U.S. Cl. CPC H04N 19/105; H04N 19/167; H04N 19/176; H04N 19/521

(57) ABSTRACT

The various implementations described herein include methods and systems for coding video. In one aspect, a method includes receiving a video bitstream comprising a current picture composed of a plurality of blocks, including a current block; identifying a reference block by applying a template-matching technique to the current block; identifying a reference vector for the reference block, where the reference vector is a motion vector or a block vector; populating a merge candidate list for the current block using the reference vector; and reconstructing the current block using information from the merge candidate list.

### RELATED APPLICATIONS

This application claims priority to U.S. Provisional Patent Application No. 63/627,685, entitled “Merge Candidate Derivation Improvement By Using Intra Template-Matching” filed Jan. 31, 2024, which is hereby incorporated by reference in its entirety.

### TECHNICAL FIELD

The disclosed embodiments relate generally to video coding, including but not limited to systems and methods for using template-matching to identify motion vector candidates.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates. ECM version 13 was published on Jul. 7, 2024 in MPEG 146.

### SUMMARY

The present disclosure describes, amongst other things, a set of methods for video (image) compression, such as using intra template matching to populate a merge candidate list that is used to reconstruct a current block. For example, a template-matching process may be applied to the current reconstructed picture to find adjacent and/or non-adjacent block(s) that have motion vector (MV) and/or block vector (BV) information that can be further used by the current block. The MV and/or BV from the adjacent or non-adjacent block may be used to construct a merge candidate list. Some embodiments include applying a template-matching processing in the current reconstructed picture to find adjacent and/or non-adjacent block(s) that have subblock-level MV and/or BV information. Some embodiments include applying a chained MV for a specific intra prediction mode, e.g., within P/B slices. This intra prediction mode may employ a template-matching approach within a predefined area in the current picture to build a list of N candidates, where N is a positive number. These candidate predictors may be ranked by the template cost in ascending order and pointed by N BVs, respectively. An index may be signaled to indicate which candidate in the list is used as the intra predictor.

The techniques in the preceding paragraph can be used to improve coding accuracy, such as by increasing merge list diversity and using MV information from a reference block that more closely matches the current block. Additionally, signaling overhead may be reduced by using the merge candidate list and signaling an index to the list and not directly signaling a MV. Compression efficiency may also be improved by populating the merge candidate list more efficiently using the methods described herein.

In accordance with some embodiments, a method of video decoding is provided. The method includes (i) receiving a video bitstream (e.g., a coded video sequence) comprising a current picture composed of a plurality of blocks, including a current block and (ii) identifying a reference block by applying a template-matching technique to the current block. The method also includes (iii) identifying a reference vector for the reference block, where the reference vector is a MV or a BV, (iv) populating a merge candidate list for the current block using the reference vector; and (v) reconstructing the current block using information from the merge candidate list.

In accordance with some embodiments, a method of video encoding includes (i) receiving video data (e.g., a source video sequence) comprising a current picture that includes a plurality of blocks, including a current block. The method includes (ii) identifying a reference block by applying a template-matching technique to the current block; (iii) identifying a reference vector for the reference block, the reference vector is a MV or a BV; (iv) populating a merge candidate list for the current block using the reference vector; and (v) encoding the current block using information from the merge candidate list.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates an example intra block copy technique in accordance with some embodiments.

FIG. 4B illustrates an example of generating a merge candidate list in accordance with some embodiments.

FIG. 4C illustrates example predefined positions in a block in accordance with some embodiments.

FIG. 4D illustrates an example chained MV in accordance with some embodiments.

FIG. 4E illustrates an example of merge candidate construction with subblock-level MV in accordance with some embodiments.

FIG. 4F illustrates another example of generating a merge candidate list in accordance with some embodiments.

FIG. 5A illustrates using a template matching process to identify a BV of a current block in accordance with some embodiments.

FIG. 5B illustrates determining an intra mode based on a most frequent mode within a found block in accordance with some embodiments.

FIG. 5C shows an example of intra template-matching refinement in accordance with some embodiments.

FIG. 6A illustrates an example video decoding process in accordance with some embodiments.

FIG. 6B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including using template matching to populate a merge candidate list that is used to reconstruct a current block. For example, a reference block may be identified by applying a template-matching technique to the current block. A reference vector (e.g., a MV or a BV) may be identified for the reference block and a merge candidate list may be generated/populated for the current block using the reference vector. Afterwards, the current block may be reconstructed using information from the merge candidate list. In another example, a list of candidate predictors is generated for the current block by applying a template-matching technique to the current block. In this example, the current block may be reconstructed using at least one candidate predictor from the list of candidate predictors.

Populating candidate lists for the current block based on a reference block identified using template matching may offer advantages including increasing coding accuracy. For example, coding accuracy may be increased by using MV information from a reference block, identified using intra-template matching, that more closely match the current block, instead of relying solely on neighboring blocks of the current block. Signaling overhead may be reduced when using the candidate list and signaling an index to the list instead of directly signaling MVs or other coding information. Coding efficiency may also be improved by populating the candidate list more efficiently, for example, based on template-matching costs, to provide better MV information for the current block.

### Example Systems and Devices

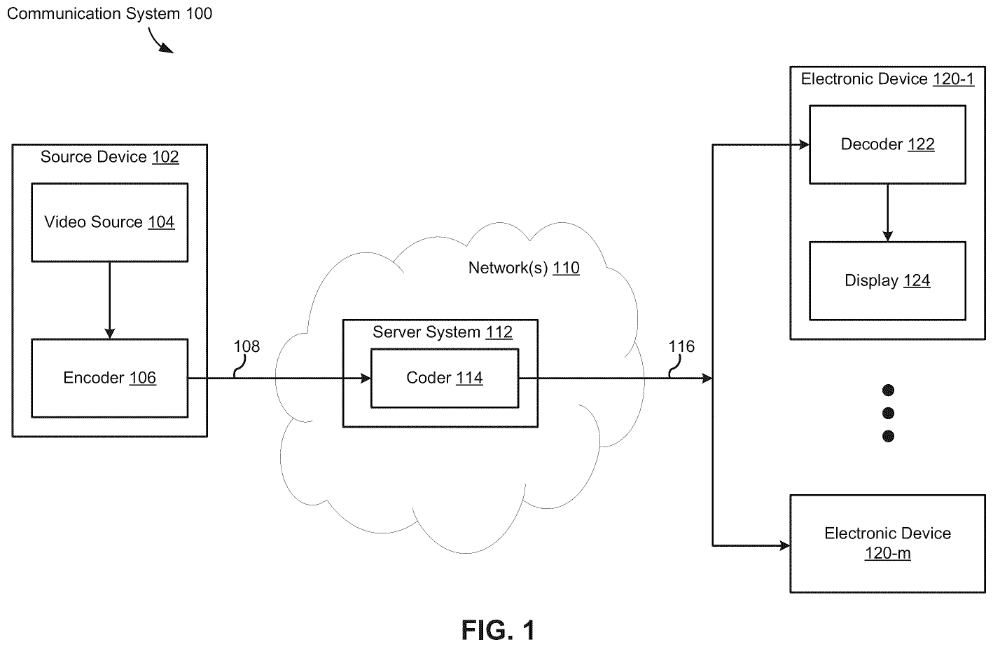

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

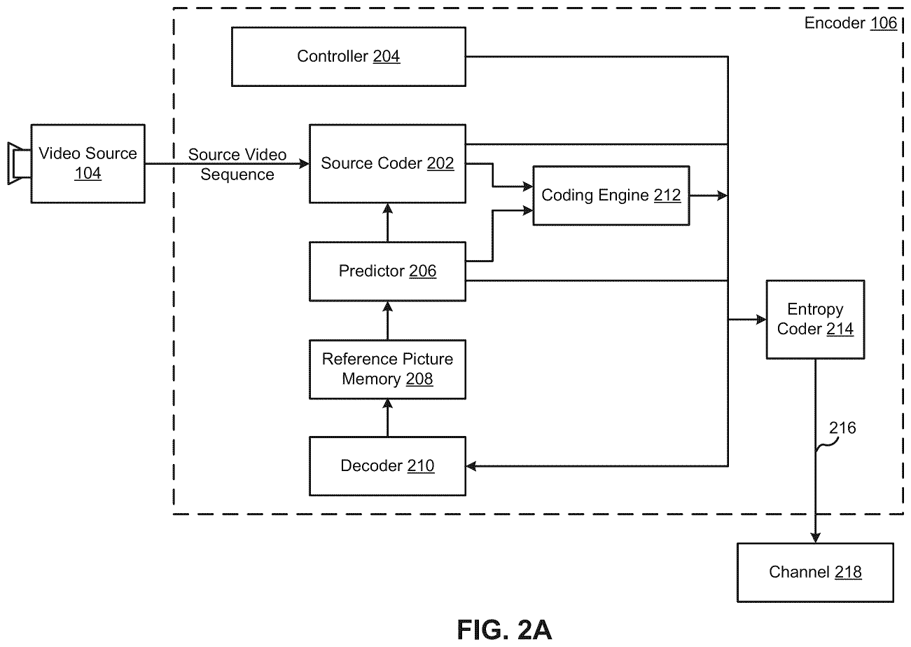

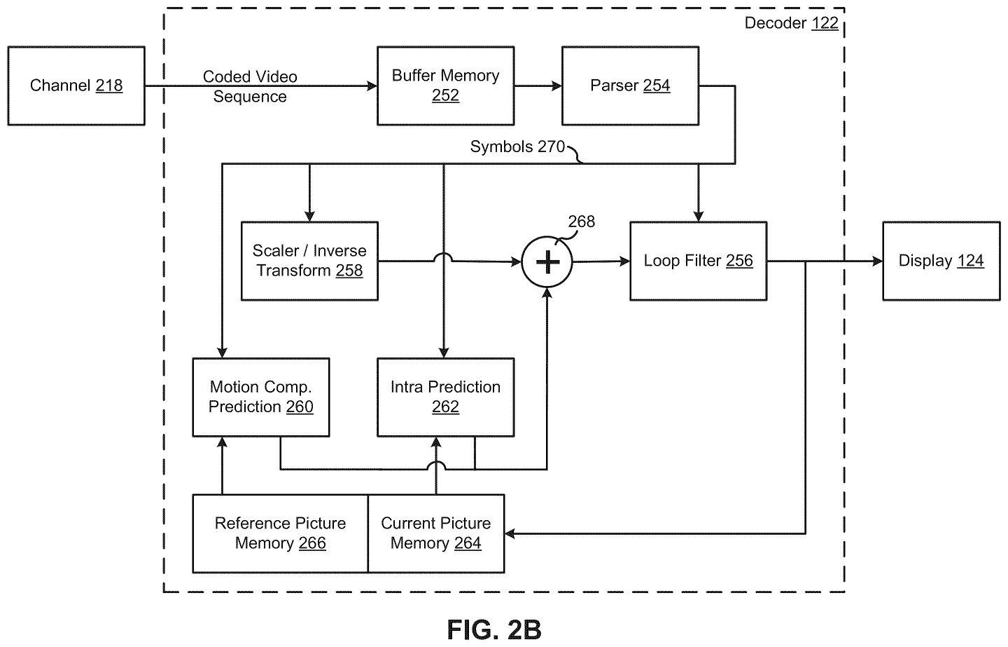

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum MV search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture MVs, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one MV and reference index to predict the sample values of each block. A Bi-directionally Predictive Picture may be coded and decoded using intra prediction or inter prediction using at most two MVs and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The MV points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, MVs, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by MVs. The MVs may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact MVs are in use, MV prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

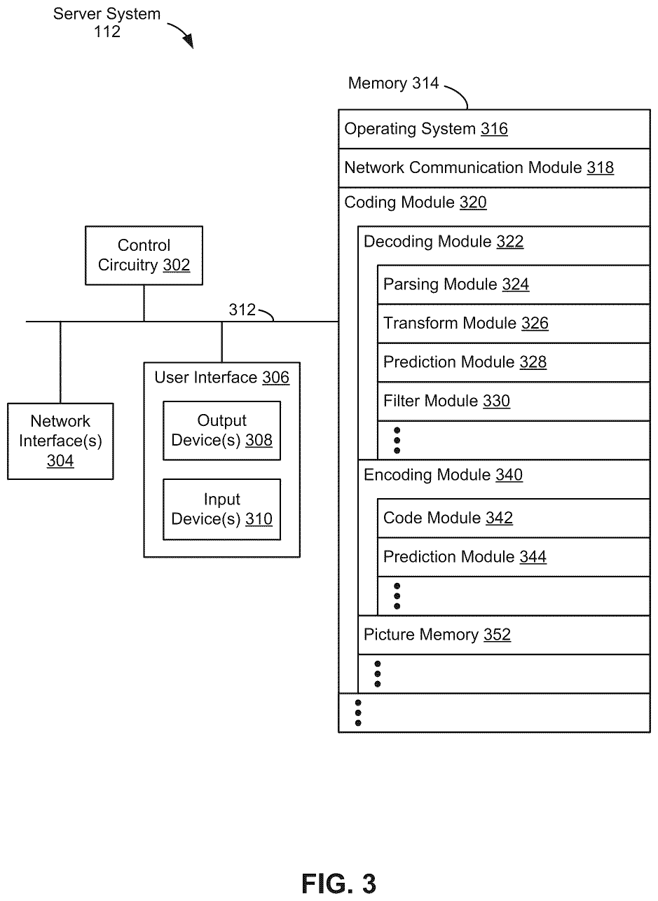

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, example methods for using template matching techniques to populate candidate lists (used to reconstruct a current blocks) are described below.

As is known to those of skill in the art, an intra block copy technique is a technique that identifies a prediction block for the current block using a BV. The BV is used to identify another block in the same picture of the current block that may be adjacent or non-adjacent to the current block. The BV may be either explicitly signaled or implicitly derived. When the BV is explicitly signaled, it is usually referred as an intra block copy (IBC) method. When the BV is implicitly derived such as by comparing a template area (a group of neighboring reconstruction samples located adjacent to the block) between the current block and a candidate prediction block, it is usually referred as an intra template matching method or a template-based intra mode derivation (TIMD) method.

In some instances, a current coding block and its neighboring samples share a similar texture characteristic. In such scenarios, the neighboring reconstructed samples of a current block, collectively called “a template,” can be employed to predict the current block. Template-matching may be used in inter prediction to derive the prediction block by calculating a distortion between the template of the current block and the template of the prediction block in the reference picture. Template-matching can also be applied in intra prediction, termed “intra template-matching,” on the reconstructed area of the current picture.

A “superblock size” or “coding tree unit (CTU)” may refer to the largest coding block size applied for coding an image/video picture or a video sequence. Additionally, block size (or region size) may refer to the block/region width, height, area, number of samples in the block/region, a max (or min) between block/region width and height, and/or block/region aspect ratio.

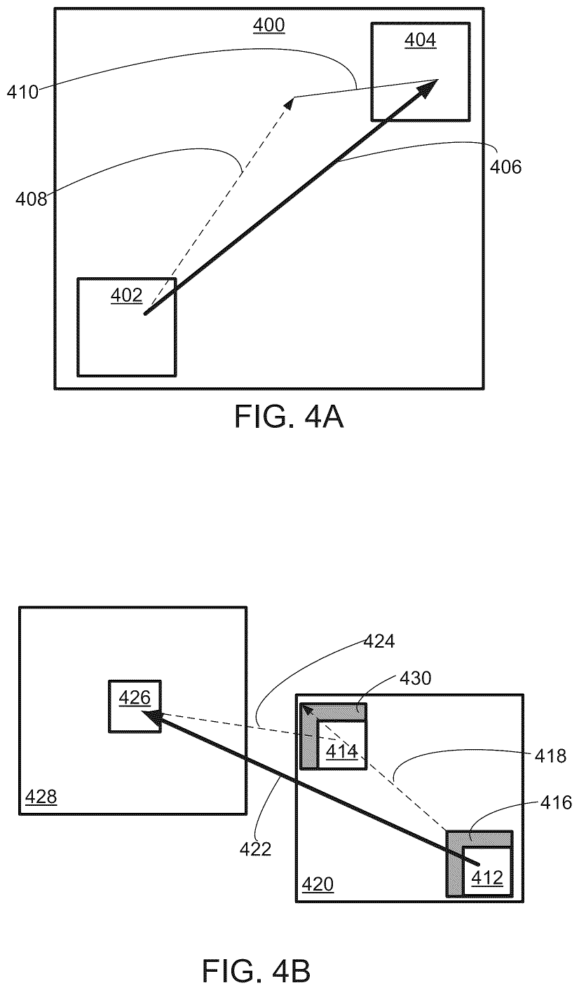

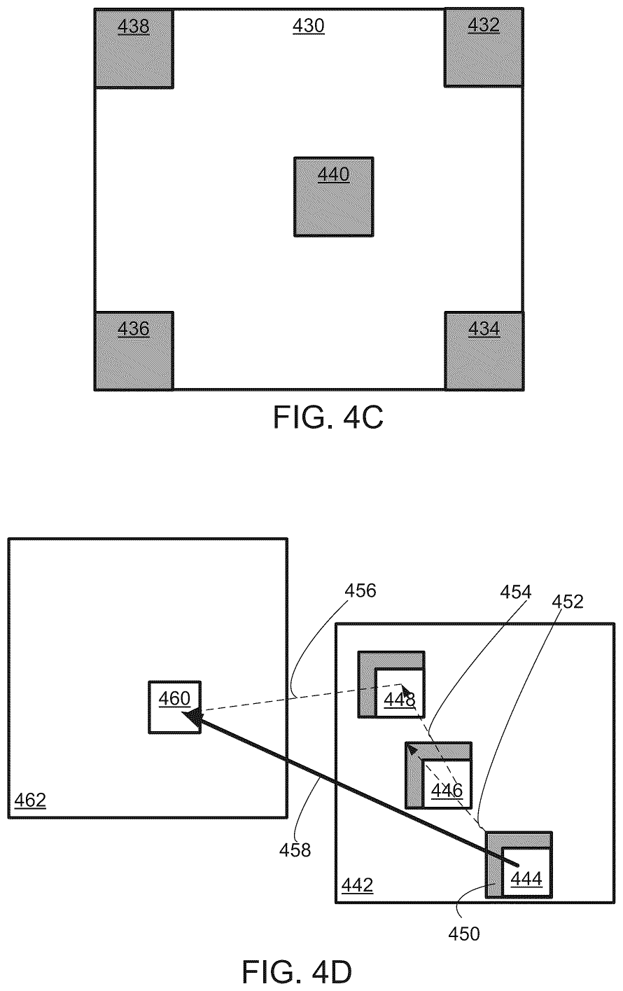

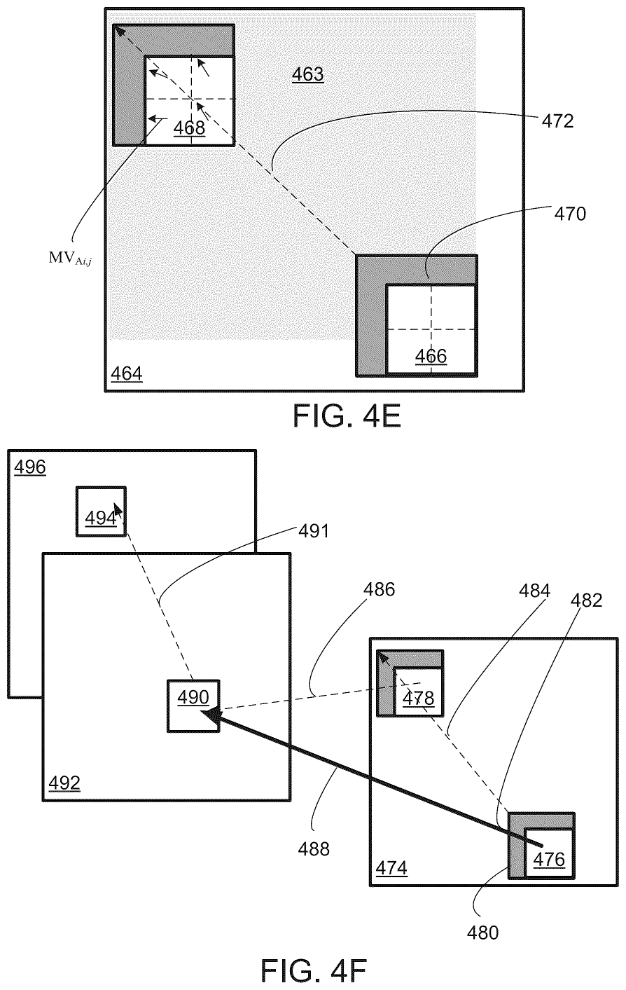

FIG. 4A illustrates an example of an intra block copy technique in accordance with some embodiments. In this example, the intra block copy technique includes identifying, via a predicted BV 408, a prediction block 404 within the same picture 400 as a current block 402. FIG. 4A shows an example in which the prediction block 404 is non-adjacent to the current block 402. In some embodiments, the prediction block 404 is adjacent to the current block 402. In some embodiments, the prediction BV 408 is selected from a list of candidate BVs. For example, the list of candidate BVs may be populated by BVs used in neighboring blocks and/or BVs from a BV bank. A BV predictor index may be signaled to indicate which candidate BV in the candidate list is used to predict the BV for the current block 402.

A block vector difference (BVD) 410 represents the difference between the predicted BV and an actual BV 406, which is the vector between corresponding portions of the current block (e.g., current block 402) and the prediction block (e.g., prediction block 404). While the BVD 410 depicted in FIG. 4A has components along both the horizontal and vertical dimensions, a BVD may extend along a single dimension or span two or more dimensions. In some embodiments, the BVD 410 includes information representing a magnitude of a BVD and/or a direction of the BVD, one or both of which may be signaled in the bitstream as intra block copy information or syntaxes.

Neighboring reconstructed samples of a current block, collectively called “a template,” may be used to predict the current block. In some embodiments, a template-matching process is applied to a current picture to find at least one adjacent and/or non-adjacent block having MV and/or BV information usable for the current block. The MV and/or BV from that adjacent block and/or non-adjacent block(s) may used to construct a merge candidate list for the current block. FIG. 4B illustrates an example of generating a merge candidate list in accordance with some embodiments. In FIG. 4B, a current picture 420 includes a current block 412. A template matching process (e.g., intra-template matching) is used to identify a BV 418 of the current block 412, in accordance with some embodiments. For example, the current block 412 has a template 416 that includes a number of reconstructed samples. A distortion between the template 416 and other templates within the current picture 420 (e.g., templates formed by reconstructed samples in the current picture 420) is calculated, and a prediction block 414 may be identified, which is associated with a template 429 having a small or smallest distortion, and/or the lowest template-matching cost (e.g., based on a sum of absolute difference (SAD), a sum of absolute transformed differences (SATD), a sum of squared error (SSE), or another metric), thereby identifying the BV 418. In the example of FIG. 4B, the predicted block 414 has a MV 424, also denoted as MV_{A′}, that points to a reference block 426 in a reference picture 428. A merge candidate 422 (e.g., also denoted as an MV) is derivable by either adding the BV 418 and the MV 424 (e.g., MV=MV_{A′}+BV), or setting the merge candidate 422 as equal the MV 424 (e.g., MV=MV_{A′}). For example, when the merge candidate 422 is set as the MV 424, the merge candidate 422 does not account for the non-adjacency of the prediction block 414 to the current block 412 (e.g., the displacement, via BV, of the prediction block 414 from the current block 412, is ignored).

In some embodiments, the merge candidate 422 (e.g., MV_{A′}) is derived from a predefined motion field within prediction block 414 having dimensions W×H. For example, the prediction block 414 (e.g., 32×32, same size as current block 412) may include multiple subblocks (e.g., each subblock having a size of 4×4, resulting in an arrangement of 8×8 different subblocks, containing 64 MVs). For example, as illustrated in FIG. 4C. the prediction block 414 in FIG. 4B may correspond to a larger block 430 (e.g., sometimes referred to as a “predefined motion field”) in FIG. 4C, which includes various subblocks, such as a top right subblock 432, a lower right subblock 434, a lower left subblock 436, a top left subblock 438 and a center subblock 440. In some embodiments, the availability of a MV within the motion field is checked by scanning the availability of MVs at one or more positions, optionally in a predefined scanning order when multiple positions are checked. In some embodiments, for example, the center subblock 440 (e.g., at a position [W/2, H/2]) is first checked to determine if MV information is available. In some embodiments, in accordance with a determination that MV information is not available at the center subblock 440, MV information is checked at the top right subblock 432, the lower right subblock 434, the lower left subblock 436, and the top left subblock 438 in sequence to determine whether MV information is available or not. If no MV at center position is available (e.g., the subblock 440 is intra coded), the MV information at the four corners (e.g., intra mode of the top left subblock 438, the top right subblock 432, the lower right subblock 434, and the lower left subblock 436 are determined in a clockwise order, or using a different order). In some embodiments, if no MV is available at those predefined locations (center, top left, top right, lower right, lower left, the subblocks at the predefined locations are intra-coded), no merge candidate 422 (e.g., MV_{A′}) is available to the current block 412 (e.g., other subblocks in the non-shaded portions of the block 430 are not checked).

A distortion or template-matching cost between the template 416 and other templates within the current picture 420 may be calculated to select a template having a low (e.g., the lowest) template-matching cost. For example, selecting at template having an associated cost that is below a predetermined threshold. In some embodiments, the template-matching cost may be based on a sum of absolute difference (SAD), a sum of absolute transformed differences (SATD), a sum of squared error (SSE), or another metric.

In some embodiments, the prediction block is searched within a smaller predefined search area within a reconstruction area of the current picture 420. For example, a search range restriction can be applied to search within a search range of a fixed size, to search within a current CTU row, to search within the current CTU row and/or to search within the N previously coded CTU row(s), etc. In some embodiments, instead of finding a single prediction block 414 (e.g., within the current picture 420), additional prediction blocks (e.g., N different prediction blocks) having the lowest N template matching costs are searched within the current picture 420 and the respective MVs within these N blocks are derived.

In some embodiments, instead of the L-shaped templates (e.g., template 416 and the template 429) shown in FIG. 4B, a template of a different shape or dimension is used for intra template-matching. For example, only a left template (e.g., left portion of the L-shaped template 416), or only a top template (e.g., the horizontal portion of the L-shaped template 416), or a top-left template (e.g., the L-shaped template 416) may be selected/used. For example, for smaller blocks (e.g. blocks smaller than or equal a size threshold such as 64, 32, or a different value), a template having two lines of reconstructed samples is used while for blocks larger than the size threshold (e.g., larger than 64, 32, or a different value), a template having four lines of reconstructed samples is used. Thus, the template size may be dependent on the block size. In some embodiments, the templates having different template-matching types and shapes are adaptively selected at the block level (e.g., using any suitable method to determine which template type is the best at the time of coding the current block) and, optionally, a syntax is signaled into the bitstream by the encoder to indicate which template type and/or shape is used.

In some embodiments, pixel subsampling within the template is used in the template-matching process to calculate the template-matching cost. For example, for a template of 32 pixels (e.g., 16×2 size), instead of calculating a pixel difference (e.g., an absolute difference) for each of the 32 pixels (e.g., all samples within the template), pixel differences are only calculated partially, for example, for just the even positions. Pixel subsampling allows a reduction in computation time and may help with hardware designs. In some embodiments, the template matching process is performed at a coarser step. For example, the step of search is changed to two samples per iteration instead of searching every sample (e.g., step size of one). For example, instead of searching every position in a 32×32 block, search is conducted at only even or only odd positions, so that the search is only conducted in a partial region.

In some embodiments, the merge candidate (e.g., merge candidate 422) is inserted into the merge candidate list before merge candidates derived from non-adjacent neighboring blocks and/or history-based motion information (e.g., MVs from previous blocks that are placed into a data buffer, such as a first in first out (FIFO) buffer). For example, merge candidates generated from prediction blocks (e.g., obtained through intra-template matching) may be closer and/or more similar to the current block, and may be more accurate than merge candidates constructed from other non-adjacent neighboring blocks.

FIG. 4D illustrates an example chained MV that includes BV and/or MV used to derive the merge candidate, in accordance with some embodiments. In FIG. 4D, a current picture 442 includes a current block 444. In some embodiments, a template matching process (e.g., intra-template matching) is used to identify a BV 452 (e.g., also denoted as BV) of the current block 444. The current block 444 has a template 450, and a distortion between the template 450 and other templates within the current picture 442 (e.g., templates formed by reconstructed samples in the current picture 442) may be calculated, and a prediction block 446 associated with a template having the smallest distortion, and/or the lowest template-matching cost (e.g., based on SAD, SATD, SSE, or another metric) is identified, analogous to the identification of the BV 418 of the current block 412 illustrated in FIG. 4B. In contrast to the prediction block 414 in FIG. 4B which has an associated MV 424, another BV 454, also denoted as BV_{A′→A″}, is derived within the BV field of the prediction block 446 in FIG. 4D. The BV 454 BV_{A′→A″} pointed to another prediction block 448 from the prediction block 446. The predicted block 448 has a MV 456, also denoted as MV_{A′}, that points to a reference block 460 in a reference picture 462. A merge MV, or a merge candidate, 458 is a chained MV is derived by adding the BV 452 (e.g., BV), the BV 454 (e.g., BV_{A′→A″}) and the MV 456 (e.g., MV_{A″}), for example, MV=BV+BV_{A′→A″}+MV_{A′}. In some embodiments, the depth of the chained MV propagation is limited. In such scenarios, for example, the depth of the chained MV propagation depicted in FIG. 4D would be two. In some embodiments, adding a BV is not considered to increase the depth of the chained MV propagation. In such scenarios, for example, the depth of the chained MV propagation depicted in FIG. 4D would be one (or zero). In some embodiments, a flag is signaled in high-level syntax, such as SPS, PPS, APS, picture header, or slice header, to indicate whether a BV is used for chained MV construction.

In some embodiments, the chained MV construction is applied with a clipping operation to ensure that the MV (e.g., MV 456) remains in a predefined area (e.g., a central portion, or in any other specific area) in the reference picture (e.g., reference picture 462).

FIG. 4E illustrates an example of merge candidate construction with subblock-level MVs, in accordance with some embodiments. In FIG. 4E, a template-matching process identifies, in a reconstructed region 463 of a current picture 464, at least one adjacent and/or non-adjacent block which has subblock-level MV and/or BV information. A prediction block 468, together with a BV 472, is derived using a template-matching process in the reconstructed region 463 of the current picture 464 for a current block 466. Within the prediction block 468, the associated subblock-level MVs are derived from the corresponding motion field covered by the prediction block 468. For example, FIG. 4E shows the lower left subblock of the prediction block 468 has a MV (e.g., pointing toward a reference subblock in a reference picture) that is pointed toward the left). A constructed merge candidate having a final subblock MV, MV_{i,j}, for each subblock (i, j) in the current block 466 may be derived by either adding the BV 472 and the respective subblock MV MV_{Ai,j} of the prediction block 468 (e.g., MV_{i,j}=MV_{Ai,j′}+BV), or setting the constructed merge candidate having the final subblock MV, MV_{i,j} for each subblock (i, j) in the current block 466 simply as respective subblock MV MV_{Ai,j} of the prediction block 468 (e.g., MV_{i,j}=MV_{Ai,j}).

In some embodiments, the constructed or derived merge candidate with subblock-level MV is not available when the subblock MV at a center position (e.g., the lower right subblock illustrated in FIG. 4E. or a subblock at another position) is not available. For example, a center position of the prediction block 468 having size W×H can be (W/2, H/2), similar to Subblock-based Temporal Motion Vector Prediction (SBTMVP). In some embodiments, if an associated subblock-level MV at any subblock (i, j) is not available in the corresponding motion field, the subblock MV at the center position is used for that subblock (e.g., fill missing information at that subblock using the information from the center subblock).

In some embodiments, a MV temporal scaling can be applied to a respective subblock level MV when a reference picture pointed by the respective subblock-level MV is not used for current block. For example, subblocks may be pointing to different reference pictures, and temporal scaling is implemented. In some embodiments, the methods described with reference to FIGS. 4A-4D are applicable to the methods described with reference to FIG. 4E.

In some embodiments, the chained MV construction process described with reference to FIG. 4D is applied for a specific intra prediction mode within a P-slice and/or a B-slice. In some embodiments, the specific intra prediction mode uses a template-matching approach within a predefined area in the current picture to build a list of N candidates, where N is a positive number. These candidate predictors (e.g., prediction blocks) are ranked according to their respective template costs in ascending order and each candidate predictor is pointed by one of N BVs from a current block to the respective candidate predictor. In some embodiments, an index is signaled to indicate which candidate in the list is used as the intra predictor. In some embodiments, the candidate predictor is expanded to a reference picture other than the current picture using the chained MV construction process. The expanded predictor may be pointed by MV=MV_{A′}+BV, where MV_{A} is the MV across pictures (e.g., from the current picture to the reference picture) and BV is the BV within the same picture, analogously described in reference to FIG. 4D.

In some embodiments, the candidate list employs a two-step strategy. In a first step, a candidate list is built with a template matching constraint to contain candidates only within the current picture. In a second step, the first M (M<=N) candidates in the list are checked to determine if the chained MVᵢ′ (e.g., MVᵢ′=MVᵢ+BVᵢ, where i is between 1 to M) constitutes a new candidate. Any new candidate motion vectors MVᵢ′ (up to M numbers of new candidate MVs) are inserted to the list of candidates from within the current picture only. For example, the insertion of candidates constructed using chained MV is appended in the candidate list, and a larger candidate list with L candidates is built, where L>N. In some embodiments, the insertion of new candidates constructed using chained MV is based on template costs and the list size is kept unchanged. For example, a highest template cost chained MV is removed from the list to include a chained MV having a lower template cost.

In some embodiments, a refinement is applied on the new candidate predictor (e.g., MV=(MVx, MVy)) pointed by the chained MV to determine if a better candidate can be when the further refinement is applied (e.g., MV′=(MVx+x0, MVy+y0)). In some embodiments, the refinement offset (x0, y0) may have multiple instances and is predefined within a search range. For example, a first template search may be done using a coarser step size, based on the found best position, a refinement is applied by searching using finer step sizes (e.g., to find a better block that approaches a global minimum for template costs), and the MV associated with the block at the refined position is used to construct the merge candidate. In some embodiments, the BV is not signaled for the refinement process.

FIG. 4F illustrates an example of merge candidate construction using additional reference pictures, in accordance with some embodiments. A current picture 474 includes a current block 476. A template matching process (e.g., intra-template matching) is used to identify a BV 484 (e.g., also denoted as BV) of the current block 476, in accordance with some embodiments. The current block 476 has a template 480 that includes a number of reconstructed samples. A distortion between the template 480 and other templates within the current picture 474 (e.g., templates formed by reconstructed samples in the current picture 474) is calculated, and a prediction block 478 is identified, which is associated with a template having the smallest distortion, and/or the lowest template-matching cost (e.g., based on a sum of absolute difference (SAD), a sum of absolute transformed differences (SATD), a sum of squared error (SSE), or another metric). The predicted block 478 has a MV 486, also denoted as MV_{A′}, that points to a reference block 490 in a reference picture 492. In some embodiments, the reference block 490 has a MV 491, also denoted as MV_{A″}, that points to another reference block 494 in another reference picture 496. For example, the current picture may be a picture order count (POC) 6 picture, and the reference picture 492 may be a POC 4 picture, having the reference block 494 that points further back to another POC picture. A merge candidate (e.g., also denoted as MV) is derived by adding the BV 484, the MV 486, and the MV 491 (e.g., MV=MV_{A″}+MV_{A′}+BV).

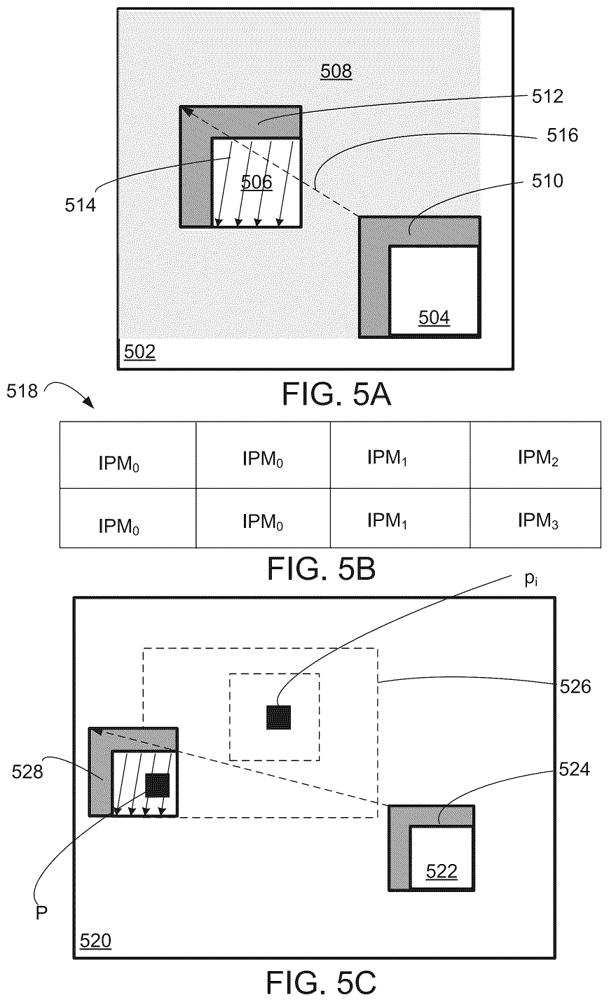

FIG. 5A shows an example where a BV of a prediction block can be determined by the intra-template matching from the reconstructed area. For example, in intra-template matching, the BV is derived by identifying a prediction block that has a template with the smallest calculated distortion between the template of the current block and the template of the prediction block. The current block may be copied from prediction block or derived by applying a filter on prediction block. Intra-template matching is one type of intra prediction method that differs from intra prediction approaches that predict the current block from neighboring reference samples. Intra prediction methods that rely on neighboring reference samples may use intra prediction modes that indicate some angular characteristics of the prediction block (e.g., the neighboring reference samples of a current block). As an example, VVC defines various directional intra modes (e.g., 45 degrees, 22.5 degrees, etc.) and non-angular modes (e.g., planar and DC modes) that can also be used when the prediction block (e.g., neighboring reference samples of a current block) has smooth texture.

In some situations, intra prediction may be improved by providing intra prediction mode information at the non-adjacent positions when constructing a most probable mode (MPM) list construction, instead of limiting to only neighboring positions (e.g., positions including a top row, a top right location, a top left location, a left row, two rows above, to rows to the left, three rows above, and three rows to the left). In some embodiments, several predefined non-adjacent positions are checked sequentially (e.g., one by one) to derive the intra prediction mode information at each non-adjacent position.

FIG. 5A illustrates using a template matching process (e.g., intra-template matching) to identify a BV of a current block, in accordance with some embodiments. A current picture 502 includes a current block 504 and a reconstructed area 508. The current block 504 is outside the reconstructed area 508. The current block 504 has a template 510 that includes a number of reconstructed samples (e.g., that are in the reconstructed area 508). A distortion between the template 510 and other templates within the reconstructed samples is calculated, and a prediction block 506 may be identified, which is associated with a template 512 having the smallest distortion, or the lowest template-matching cost (e.g., based on a sum of absolute difference (SAD), a sum of absolute transformed differences (SATD), a sum of squared error (SSE), or another metric). FIG. 5A shows an example in which the prediction block 506 is non-adjacent to the current block 504. In some embodiments, the prediction block is adjacent to the current block 504. In some embodiments, instead of searching the entire reconstruction area 508, the prediction block can be searched within a smaller predefined search area within the reconstruction area 508. In some embodiments, a search range restriction can be applied to the intra template-matching to search within a search range of a fixed size, to search within a current CTU row, to search within the current CTU row and/or to search within the N previously coded CTU row(s), etc.

A BV 516 of the current block 504 is derived via a vector that points from the current block 504 (e.g., from a portion of the template 510 of the current block 504, to a corresponding portion of the template 512 of the prediction block 506) to the prediction block 506. In some embodiments, the prediction block 506 include intra prediction information, such as an intra prediction mode. In the example illustrated in FIG. 5A, the intra prediction mode of the prediction block 506 is a directional intra-prediction mode (e.g., mode 61 in the vertical set, pointing to the lower left corner). In some embodiments, the intra prediction mode information x (e.g., intra prediction mode) of the prediction block 506 is derived and used for the prediction of the current block 504 (e.g., the intra prediction mode of the current block 504 is set to be mode 61).

In some embodiments, instead of finding a single prediction block 506 (e.g., within the reconstruction area 508, or within a predefined search area within the reconstruction area 508), additional prediction blocks (e.g., N prediction blocks) having the lowest N template matching costs are searched and the respective intra prediction modes within these N blocks are derived.

In some embodiments, the prediction block 506 may include multiple blocks, e.g., as described above with reference to FIG. 4C. For example, the prediction block 506 may correspond to the larger block 430 in FIG. 4C, which includes various blocks, such as a top right block 432, a lower right block 434, a lower left subblock 436, a top left subblock 438 and a center subblock 440. The intra mode information for the current block 504 in FIG. 5A may be determined based on a block from a predefined position within the prediction block 506. In some embodiments, the predefined positions are checked in a predefined order, and the intra mode is derived by the first available intra mode in a predefined scan order (e.g., start from the center position, move to the top-right position and proceed in a clockwise direction). For example, the prediction block 506 (and the block 430) may have a width W and a height H, and the subblock 440 at the center position (e.g., [W/2, H/2]) is checked first to determine whether its intra prediction mode is available or not. If the intra mode at center position is not available (e.g., the subblock 440 is inter coded), the intra mode information at the four corners (e.g., intra mode of the top left subblock 438, the top right block 432, the lower right block 434, and the lower left subblock 436 are determined in a clockwise order, or using a different order). In some embodiments, if no intra mode information is available at those predefined locations (center, top left, top right, lower right, lower left, the blocks at the predefined locations are inter-coded), intra mode is not available to the current block 504 (e.g., other blocks in the non-shaded portions of the block 430 are not checked).

In some embodiments, an intra mode information derived from one of the predefined locations (e.g., intra mode of the center subblock 440, the top left subblock 438, the top right subblock 432, the lower right subblock 434) includes another BV, and additional intra mode information is derived from a corresponding block pointed to by the BV.

In some embodiments, the availability of intra prediction mode is determined by scanning all positions within the intra mode information field covered by the founded block (e.g., including the non-shaded portions of the block 430 in FIG. 4C). For example, the intra mode information field correspond to the enter block 430. The intra prediction mode of the current block 504 may be set to any intra prediction mode found within the block 430. Otherwise, the intra prediction mode is not available from the block 430. For example, the found block may be partially inter-predicted and partially intra-predicted. In such scenarios, the intra prediction mode for the found block is deemed to not have been found.

FIG. 5B illustrates determining an intra mode based on a most frequent mode within a found block, in accordance with some embodiments. In some embodiments, when a similar block 518 is found using the template-matching approach, its intra mode is derived as the most frequent mode within the found block (e.g., the similar block 518). For example, for a minimum intra prediction block size of 4×4, if the size of the similar block 518 is 16×8, the found similar block 518 is divided into a (16/4)×(8/4)=4×2 grid. For each grid cell, an intra mode is derived and the most frequent intra mode (IPM₀, which is the intra mode for four grid cells in the similar block 518, is more frequent than the mode IPM₁, which is the intra mode for two grid cells, and the modes IPM₂ and IPM₃, each is the intra mode for one grid cell) within the grid is selected as the intra mode for the found similar block 518. In some embodiments, an intra mode may be placed in the MPM list but may not be used.

In some embodiments, the template-matching approach described above in reference in FIGS. 5A and 5B are applied to a most probable mode (MPM) list. In some embodiments, the MPM list collects the most probable modes of a current block (e.g., current block 504) using a predefined construction rule at both the encoder and at the decoder. In some embodiments, an index of the MPM list is signaled in the bitstream by the encoder and the final intra mode can be derived with the MPM list and the signaled index at the decoder. The encoder and the decoder may use the same rule to get the same intra mode information. For example, the intra mode derived using the template-matching approach (e.g., based on the intra prediction information x of the prediction block 506) is added in the MPM list before intra mode candidates from non-adjacent blocks. In some cases, the intra mode derived using template-matching approach is added to the MPM list and sorted together with intra mode candidates from non-adjacent blocks.

In some embodiments, instead of the L-shaped templates (e.g., template 510 and the template 512) shown in FIG. 5A, a template of a different shape is used for intra template-matching. For example, only a left template (e.g., left portion of the L-shaped template 510), or only a top template (e.g., the horizontal portion of the L-shaped template 510), or a top-left template (e.g., the L-shaped template 510) is used. For example, the current block may be more correlated in one direction (e.g., a horizontal direction or a vertical direction), and a left template or a top template may provide more accurate results. For example, for smaller blocks (e.g. blocks smaller than or equal a size threshold such as 64, 32, or a different value), a template having two lines of reconstructed samples is used while for blocks larger than the size threshold (e.g., larger than 64, 32, or a different value), a template having four lines of reconstructed samples is used. In some embodiments, the templates having different template-matching types and shapes are adaptively selected at the block level and a syntax is signaled into the bitstream by the encoder to indicate which template type and/or shape is used.

In some embodiments, pixel subsampling within the template is used in the template-matching process to calculate the template-matching cost, as a complexity reduction approach. For example, template matching may be time consuming and pixel subsampling may reduce latency of template matching. In some embodiments, the template matching process is performed at a coarser step. For example, the step of search is changed to two samples per iteration instead of searching every sample (e.g., step size of one). In some embodiments, a flag is signaled in high-level syntax, such as SPS, PPS, APS, picture header, or slice header, to indicate whether the intra template matching is used to derive intra prediction mode information.

FIG. 5C shows an example of intra template-matching refinement to find a position of a prediction block having the smallest template-matching cost, in accordance with some embodiments. A non-adjacent position pᵢ to a current block 522 in a current picture 520 is used to derive an intra prediction mode through refinement. The template-matching refinement is applied around the non-adjacent position pᵢ, within a template-matching search range 526, to find a prediction block P, that has a smallest template-matching cost (e.g., the distortion between the template 524 of the current block 522 and the template 528 of the prediction block P is the smallest) within the template-matching search range 526. The associated intra prediction mode of the prediction block P is used for the current block 522.

In some embodiments, the MPM list is constructed by applying the refinement process on a non-adjacent position of the current block 412. In some embodiments, in accordance with a determination that the template-matching costs associated with a position in the refinement process is smaller or equal to a predefined threshold value, the intra prediction mode derived at the position determined via the refinement process is applied to the construction of the MPM list. In some embodiments, in accordance with a determination that the template-matching costs associated with a position in the refinement process is greater than the predefined threshold value, the intra prediction mode derived at the position determined via the refinement process is not applied to the construction of the MPM list. In some embodiments, the predefined threshold value is a quantization parameter (QP) dependent value.

In some embodiments, in accordance with a determination that the prediction block having the lowest template-matching cost does not have associated intra prediction mode information (e.g., the prediction block having the lowest template-matching cost is inter coded), a second lowest template-matching cost (e.g., the second least cost) is used to derive the intra prediction mode (e.g., optionally, going through a ranked list of template-matching costs until an intra prediction mode information is determined).

In some embodiments, the position of the block (e.g., the prediction block P, or the non-adjacent position pᵢ) for the template-matching can be at the any position within a similar block, for example, as shown in FIG. 5C. For example, the prediction block P, or the non-adjacent position pᵢ corresponds to the block 430 of FIG. 4C, or the position of the non-adjacent position pᵢ is the center position [W/2, H/2] of the block for template-matching or any corner positions of the block as illustrated in FIG. 4C. In some embodiments, the methods and techniques described with reference to FIGS. 5A and 5B can be applied to the methods described with reference to FIG. 5C.

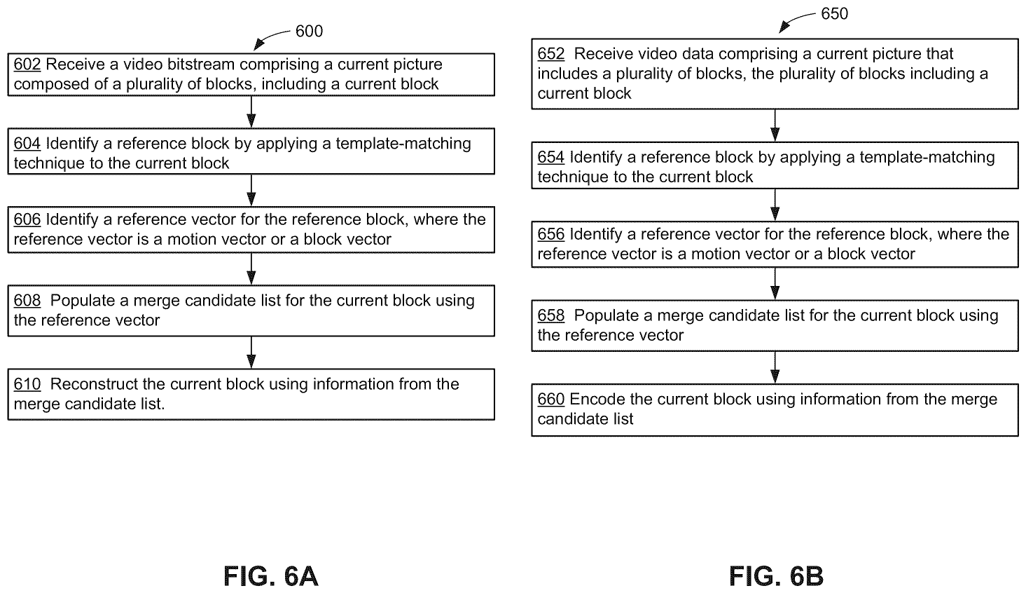

FIG. 6A is a flow diagram illustrating a method 600 of decoding video in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a video bitstream (e.g., a coded video sequence) comprising a current picture composed of a plurality of blocks, including a current block. The system identifies (604) a reference block by applying a template-matching technique to the current block and identifies (606) reference vector for the reference block, where the reference vector is a MV or a BV. The system populates (608) a merge candidate list for the current block using the reference vector and reconstructs (610) the current block using information from the merge candidate list. In this way, a template-matching processing may be applied in a current reconstructed picture to find at least one adjacent and/or non-adjacent block which has MV and/or BV information. The MV and/or BV from the block can then be used to construct a merge candidate list. One example is shown in FIG. 4B. For example, a BV of block A′ may be determined by the template matching process and another motion vector MV_{A}′ may be derived from coded block A′ that points to a reference picture which is used for coding the current block A. Finally, a constructed merge candidate with MV which is equal to MV_{A′}+BV may be constructed in a merge list as shown in FIG. 4B by using intra template-matching. Another example in FIG. 4B shows that the MV of the derived constructed merge candidate can be equal to MV_{A′}.

In some embodiments, a derived motion vector MV_{A′} is derived from a predefined motion field within the W×H block A′. The availability of a MV within the motion field is checked by scanning the availability of MV at no less than one position and this scanning order is a predefined order if multiple positions are checked. FIG. 4C shows an example of the MV derivation. The system determines if a MV is available or not at a center position [W/2, H/2]. If no MV at the center position is available, the MV information at four corners is determined in sequence. In some embodiments, the derived motion vector MVA′ is not available if there is no available MV derived from the above-listed positions. In some embodiments, the template-matching cost is SAD, SATD, SSE, or the like. In some embodiments, a search area of the intra template-matching is within the reconstructed current picture. In some embodiments, a search range restriction is applied to the intra template-matching, for example, within a search range with a fixed size, within a current CTU row, within the current CTU row and N previous coded CTU row(s), etc. In some embodiments, more than one MV is derived by sorting template-matching cost in ascending order. For example, MVs from N blocks which have N smallest template-matching cost during the template-matching process may be sorted. In some embodiments, different template-matching types are used for intra template-matching. In some embodiments, only left template, top template, or top-left template is used. In some embodiments, for smaller blocks (e.g. smaller than or equal to 64) template size is 2 lines while for other case is 4 lines. In some embodiments, these different template-matching types can be used adaptively at block level and a syntax is signaled to indicate which template type is used. In some embodiments, pixel subsampling within the template can be used during the template-matching process to calculate the template-matching cost. In some embodiments, the template matching process is performed at a coarser step. For example, the step of search is changed to two samples per iteration instead of one. In some embodiments, the constructed merge candidate is inserted before the merge candidates derived from the non-adjacent neighboring blocks and/or history-based motion information.

In some embodiments, a chained MV which includes a BV and/or a MV can be used to derive the merge candidate by using intra template-matching. FIG. 4D shows an example of merge MV derivation with chained MV and BV by using intra template-matching. A block A′ is derived using the intra template-matching process. The associated BV_{A′→A″} is derived from the corresponding BV field within block A′, and the block vector BV_{A′→A″} points to block A″. Another motion vector, MV_{A″}, is derived from block A″. And then the chained MV, BV_{A′→A″}+MV_{A″}, can be used with BV to construct the merge MV.

In some embodiments, the depth of chained MV propagation is limited. In some embodiments, adding BV is not considered to increase the depth of the chained MV propagation.

In some embodiments, a flag is signaled in high level syntax such as SPS, PPS, APS, picture header, slice header, to indicate whether the BV is used for chain MV predictor construction or not.

In some embodiments, the chained MV methodologies and systems described herein are applied with a clipping operation, e.g., in order to limit the MV to within a predefined restricted area in the reference picture.

The disclosed methodologies and systems include applying a template-matching processing in the current reconstructed picture to find at least one adjacent and/or non-adjacent block which have subblock-level MV and/or BV information. An example of merge candidate construction with subblock-level MV is shown in FIG. 4E. A block A and its BV are derived using template-matching processing in the current reconstrued picture. Within the block A, the associated subblock-level MVs are derived from the corresponding motion field which is covered by the block A. Finally, the constructed merge candidate is constructed and the final subblock motion vector, MV_{i,j}, for each subblock (i, j) can be set equal to MV_{Ai,j}+BV. Moreover, the final subblock motion vector MV_{i,j}, for each subblock (i, j) can also be set equal to MV_{Ai,j}. In some embodiments, the derived merge candidate with subblock-level MV is not valid when the subblock MV at a center position is not available. The center position of block A with size W×H can be but is not limited to be (W/2, H/2). In some embodiments, the subblock MV at the center position described above is used for this subblock, if the associated subblock-level MV at subblock (i, j) is not available in the corresponding motion field.

In some embodiments, a MV temporal scaling is applied to each subblock-level MV when the reference picture pointed by that subblock-level MV is not used for current block.

The methodologies and systems described herein include applying the chained MV described above for a specific intra predict mode within the P/B slices. This intra prediction mode employs template-matching approach within a predefined area in the current picture to build a list of N candidates, wherein N is a positive number. These candidate predictors are ranked by the template cost in ascending order and pointed by N BVs, respectively. An index is signaled to indicate which candidate in the list is used as the intra predictor.

In some embodiments, the candidate predictor is expanded to a reference picture other than the current picture using the chained MV. This expanded predictor is pointed by MV=MVA′+BV, where MVA′ is the MV across pictures and BV is the BV within the same picture. In some embodiments, populating the candidate list includes employing a two-step strategy: in the first step, the candidate list is built with a template matching constraint to include only candidates within the current picture. In the second step, the first M (M<=N) candidates in the list is/are picked up and they are checked to see if they correspond to new candidates with chained motion vector MVᵢ′=MVᵢ+BVᵢ, wherein i is the iterator between 1 to M. These new candidates pointed by MVᵢ′ (up to M) are inserted to the list consisting of candidates within the current picture only. In some embodiments, the insertion of candidates with chained MV is appended in the candidate list, and a large candidate list with L candidates is built, wherein L>N. In some embodiments, the insertion is based on template cost and the list size is kept unchanged.

In some embodiments, a refinement is applied on the new candidate predictor pointed to by the chained MV. Suppose a new candidate predictor pointed to by MV (MVx, MVy) is found with method described above, a further refinement is applied with MV′ (MVx+x0, MVy+y0) to search for better candidates. The refinement offset (x0, y0) can have multiple instances and is predefined within a search range.

FIG. 6B is a flow diagram illustrating a method 650 of encoding video in accordance with some embodiments. The method 650 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 650 is performed by a same system as the method 600 described above.

The system receives (652) video data (e.g., a source video sequence) comprising a current picture that includes a plurality of blocks, including a current block. The system identifies (652) a reference block by applying a template-matching technique to the current block and identifies (656) a reference vector for the reference block, where the reference vector is a MV or a BV. The system populates (658) a merge candidate list for the current block using the reference vector and encodes (660) the current block using information from the merge candidate list. As described previously, the encoding process may mirror the decoding processes described herein (e.g., template matching and merge candidate list construction as described above). For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 600) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a current picture composed of a plurality of blocks, including a current block and (ii) identifying a reference block by applying a template-matching technique to the current block. The method also includes (iii) identifying a reference vector for the reference block, where the reference vector is a MV or a BV, (iv) populating a merge candidate list for the current block using the reference vector; and (v) reconstructing the current block using information from the merge candidate list. For example, a template-matching process is applied in a current reconstructed picture to find at least one adjacent and/or non-adjacent block which has MV and/or BV information. The at least one MV and/or BV from the block is used to construct the merge candidate list. As an example, a BV is determined via a template matching process. A MV is derived from a reference block pointed to by the BV. The MV points to a reference picture that is used in the current block. A constructed merge candidate with the MV is added in a merge list for the current block. The constructed merge candidate may consist of the MV or may include the MV combined with the BV. In some embodiments, the current block corresponds to a P or B slice. In some embodiments, reconstructing the current block using the information from the merge candidate list comprises selecting a vector from the merge candidate list and reconstructing the current block using the vector. In some embodiments, an index is signaled in the video bitstream to indicate which candidate vector from the merge candidate list is to be used to reconstruct the current block.

(A2) In some embodiments of A1, populating the merge candidate list using the reference vector includes populating the merge candidate list with a combined vector generated by combining a BV obtained from the template-matching technique with the reference vector for the reference block. In some embodiments, the combined vector is clipped to be within a predefined area. For example, the chained MV is applied with a clipping operation to ensure that the MV is within a predefined restricted area in the reference picture. In some embodiments, a refinement is applied to the combined vector prior to insertion into the merge candidate list. In some embodiments, a refinement amount is signaled in the video bitstream. In some embodiments, the refinement amount is predefined for the current block.

(A3) In some embodiments of A2, the combined vector is inserted before at least one of: merge candidates from non-adjacent neighboring blocks, and history-based motion information. For example, the constructed merge candidate is inserted before the merge candidates derived from the non-adjacent neighboring blocks and/or history-based motion information.

(A4) In some embodiments of any of A1-A3, populating the merge candidate list using the reference vector comprises populating the merge candidate list with the reference vector. In some embodiments, an indicator is parsed from the video bitstream, the indicator indicating whether to combine the BV from the template-matching technique with the reference vector. For example, a flag is signaled in high-level syntax to indicate whether the BV is used for lookahead (chain) MV predictor construction.

(A5) In some embodiments of any of A1-A4, the reference vector is identified by checking at least one position of the reference block. For example, the derived MV is derived from the predefined motion field within the reference block. The availability of MV within the motion field may be checked by scanning the availability of MV at not less than one position and this scanning order may be a predefined order if multiple positions are checked.

(A6) In some embodiments of A5, the at least one position comprises a center position of the reference block. For example, first the center position (e.g., position at width/2, height/2) is checked to determine whether its MV is available. In an example, if the MV at center position is not available, the MV information at the four corners are checked in sequence. In some embodiments, the derived merge candidate with a subblock-level MV is not valid when the subblock MV at center position is not available.

(A7) In some embodiments of A5 or A6, the reference vector is identified by checking a center position of the reference block and one or more corner positions of the reference block in accordance with a predefined scanning order.

(A8) In some embodiments of any of A5-A7, when the at least one position of the reference block does not have an available reference vector, the method includes forgoing populating the merge candidate list with a vector corresponding to the reference block. For example, the derived MV is not available if there is no available MV derived from the above positions.

(A9) In some embodiments of any of A1-A8, applying the template-matching technique comprises deriving a template-matching cost. For example, the template-matching cost may be a sum of absolute differences (SAD), a sum of absolute transformed differences (SATD), and/or a sum of squared errors (SSE).

(A10) In some embodiments of any of A1-A9, the template-matching technique is applied to a search area corresponding to a reconstructed portion of the current picture. For example, the search area of the intra template-matching is within the reconstructed current picture. In some embodiments, a search range restriction is applied to the intra template-matching. For example, the search range may be a fixed size, e.g., within current CTU row or within the current CTU row and N previous coded CTU row(s).

(A11) In some embodiments of any of A1-A10, the method further includes identifying a second reference block by applying the template-matching technique to the reference block or the current block; identifying a second reference vector for the second reference block; and populating the merge candidate list with the second reference vector. For example, more than one MVs can be derived by using template-matching cost in ascending order. As an example, MVs from N blocks which have N smallest template-matching cost are identified during the template-matching process.

(A12) In some embodiments of any of A1-A11, the method further includes identifying a template-matching type from a set of template-matching types, the template-matching technique is applied using the template-matching type. For example, different template-matching types can be used for the intra template-matching process. As an example, the set of template-matching types may include an only-left template, an only-top template, and/or a top-left template. As an example, for smaller blocks (e.g., smaller than or equal to 64 samples), a template size of 2 lines may be used, while for larger blocks a template size of 4 lines may be used. In some embodiments, the different template-matching types are used adaptively, e.g., at a block level. In some embodiments, a syntax is signaled to indicate which template type is used.

(A13) In some embodiments of any of A1-A12, the template-matching technique uses a subsampled template. For example, pixel subsampling within the template can be used during the template-matching process to calculate the template-matching cost. In some embodiments, the template matching process is performed at a coarse step size. For example, the step of search is changed to two samples per iteration instead of one.

(A14) In some embodiments of any of A1-A13, the reference vector is a BV; and the method further includes identifying a second reference block using the BV; and identifying a second reference vector for the second reference block, the merge candidate list is populated using the second reference vector. For example, a chained MV which includes BV and/or MV can be used to derive the merge candidate by using intra template-matching. A reference block A′ is derived by using the intra template-matching process. The associated BV of reference block A′ is derived from the corresponding BV field within the block A′ and a second reference block A″ is pointed by the BV. Another motion vector, MVA″, is derived from block A″. As an example, the chained MV equal to the BV and the motion vector, MV_{A″}, can be used with a BV identified using the template-matching technique to construct the merge MV.

(A15) In some embodiments of A14, the second reference block is identified in accordance with an allowed chain depth. For example, the depth of the chained MV propagation is limited (e.g., restricted to 1, 2, or 3 BVs). In some embodiments, adding the BV it is not considered to increase the depth of the chained MV propagation. In some embodiments, subsequent reference blocks are identified in accordance with corresponding BVs until a chain depth limit reached. In some embodiments, in accordance with the chain depth limit being reached, the merge candidate list is not populated using the reference vector chain.

(A16) In some embodiments of any of A1-A15, the reference vector for the reference block comprises a subblock-level MV. For example, a template-matching processing is applied in a current reconstructed picture to find at least one adjacent and/or non-adjacent block which has subblock-level MV and/or BV information. A block A together with a BV is derived by using a template-matching process in the current reconstrued picture. Within the block A, the associated subblock-level MVs are derived from the corresponding motion field which is covered by the block A. In this example, the constructed merge candidate is constructed and the final subblock MV for each subblock can be equal to subblock MV plus the BV. In another example, the final subblock MV for each subblock can be equal to the subblock MV (e.g., without the BV).

(A17) In some embodiments of A16, the subblock-level MV for the reference block corresponds to a center position of the reference block. For example, the subblock MV at the center position is used for a different subblock, if the associated subblock-level MV at the subblock is not available in the corresponding motion field.

(A18) In some embodiments of any of A1-A17, the reference vector comprises a MV pointing to a reference picture that is not used by the current block; and the method further comprises applying temporal scaling to the MV. For example, a MV temporal scaling can be applied to each subblock level MV when the reference picture pointed by that subblock-level MV is not used for current block.

(B1) In another aspect, some embodiments include a method (e.g., the method 650) of video encoding. In some embodiments, the method is performed at a computing system (e.g., the server system 112) having memory and control circuitry. In some embodiments, the method is performed at a coding module (e.g., the coding module 320). The method includes (i) receiving video data (e.g., a source video sequence) comprising a current picture that includes a plurality of blocks, including a current block. The method includes (ii) identifying a reference block by applying a template-matching technique to the current block; (iii) identifying a reference vector for the reference block, the reference vector is a MV or a BV; (iv) populating a merge candidate list for the current block using the reference vector; and (v) encoding the current block using information from the merge candidate list. Some embodiments of B1 include applying any of the techniques described above in A2-A18.

(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes: (i) obtaining a source video sequence that comprises a plurality of frames; and; (ii) performing a conversion between the source video sequence and a video bitstream of visual media data according to a format rule, the video bitstream comprises a current block corresponding to a current picture; and the format rule specifies that: (a) a reference block is to be identified by applying a template-matching technique to the current block; (b) a reference vector is to be identified for the reference block, the reference vector is a MV or a BV; (c) a merge candidate list for the current block is to be populated using the reference vector; and (d) the current block is to be reconstructed using information from the merge candidate list.

(D1) In another aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a current picture composed of a plurality of blocks, including a current block; (ii) generating a list of candidate predictors for the current block by applying a template-matching technique to the current block; and (iii) reconstructing the current block using at least one candidate predictor from the list of candidate predictors. As an example, an intra prediction mode employs a template-matching approach within a predefined area in the current picture to build a list of N candidates, where N is a positive integer. These candidate predictors may be ranked by the template cost in ascending order and pointed by N BVs, respectively. An index may be signaled to indicate which candidate in the list is used as the intra predictor.

(D2) In some embodiments of D1, a candidate predictor from the list of candidate predictors is derived based on a BV identified via the template-matching technique and a MV of a reference block indicated by the BV. In some embodiments, a candidate predictor is expanded to a reference picture other than the current picture using a chained MV. The expanded predictor may be pointed by MV=MV_{A′}+BV, where MV_{A′} is the MV across pictures and BV is the BV within the same picture.

(D3) In some embodiments of D2, the candidate predictor is derived by refining a combined vector combining the BV and the MV. For example, a refinement is applied on the new candidate predictor pointed by the chained MV. An example candidate predictor pointed by MV (MVx, MVy) is found and a further refinement applied with MV′ (MVx+x0, MVy+y0) is performed to search better candidates. The refinement offset (x0, y0) can have multiple instances and may be predefined within a search range. In some embodiments, the candidate predictor is used to identify a different predictor within the current picture (e.g., based on a cost calculation). For example, the new candidate predictor pointed by the chained MV can be used to refine the origin predictor pointed by the BV. A cost may be calculated between the new predictor and reconstructed block around of the origin predictor with a search window.

(D4) In some embodiments of any of D1-D3, generating the list of candidate predictors comprises: inserting a first set of candidate predictors constrained to the current picture into the list of candidate predictors; and inserting a second set of candidate predictors corresponding to chained MVs into the list of candidate predictors. For example, the candidate list employs a two-step strategy: in the 1st step, the candidate list (e.g., of size N) is built with template matching constraint to candidates only within the current picture. In the 2nd step, the first M (M<=N) candidates in the list is/are picked up and they are checked to consist of a new candidate with chained motion vector MV_{i′}=MVᵢ+BVᵢ, wherein i is the iterator between 1 to M. These new candidates pointed by MV_{i′} (up to M) are inserted to the list consisting of candidates within the current picture only. In one example, the insertion of a candidate with chained MV is appended in the candidate list, and a large candidate list with L candidates is built, where L>N. In another example, the insertion is based on template cost and the list size is kept unchanged.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A18, B1, C1, and D1-D4 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18, B1, C1, and D1-D4 above). In some embodiments, a non-transitory computer-readable storage medium stores a video bitstream that is generated by any of the video encoding methods described herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a current picture composed of a plurality of blocks, including a current block;
identifying a reference block by applying a template-matching technique to the current block;
identifying a reference vector for the reference block, wherein the reference vector is a motion vector or a block vector;
populating a merge candidate list for the current block using the reference vector; and
reconstructing the current block using information from the merge candidate list.

2. The method of claim 1, wherein populating the merge candidate list using the reference vector comprises populating the merge candidate list with a combined vector generated by combining a block vector obtained from the template-matching technique with the reference vector for the reference block.

3. The method of claim 2, wherein the combined vector is inserted before at least one of: merge candidates from non-adjacent neighboring blocks, and history-based motion information.

4. The method of claim 1, wherein populating the merge candidate list using the reference vector comprises populating the merge candidate list with the reference vector.

5. The method of claim 1, wherein the reference vector is identified by checking at least one position of the reference block.

6. The method of claim 5, wherein the at least one position comprises a center position of the reference block.

7. The method of claim 5, wherein the reference vector is identified by checking a center position of the reference block and one or more corner positions of the reference block in accordance with a predefined scanning order.

8. The method of claim 5, further comprising:
when the at least one position of the reference block does not have an available reference vector, forgoing populating the merge candidate list with a vector corresponding to the reference block.

9. The method of claim 1, wherein applying the template-matching technique comprises deriving a template-matching cost.

10. The method of claim 1, wherein the template-matching technique is applied to a search area corresponding to a reconstructed portion of the current picture.

11. The method of claim 1, further comprising
identifying a second reference block by applying the template-matching technique to the reference block;
identifying a second reference vector for the second reference block; and
populating the merge candidate list with the second reference vector.

12. The method of claim 1, further comprising identifying a template-matching type from a set of template-matching types, wherein the template-matching technique is applied using the template-matching type.

13. The method of claim 1, wherein the template-matching technique uses a subsampled template.

14. The method of claim 1, wherein the reference vector is a block vector; and
wherein the method further comprises:
identifying a second reference block using the block vector; and
identifying a second reference vector for the second reference block, wherein the merge candidate list is populated using the second reference vector.

15. The method of claim 14, wherein the second reference block is identified in accordance with an allowed chain depth.

16. The method of claim 1, wherein the reference vector for the reference block comprises a subblock-level motion vector.

17. The method of claim 16, wherein the subblock-level motion vector for the reference block corresponds to a center position of the reference block.

18. The method of claim 1, wherein:
the reference vector comprises a motion vector pointing to a reference picture that is not used by the current block; and
the method further comprises applying temporal scaling to the motion vector.

19. A method of video encoding performed at a computing system having memory and one or more processors, the method comprising:
receiving video data comprising a current picture that includes a plurality of blocks, the plurality of blocks including a current block;
identifying a reference block by applying a template-matching technique to the current block;
identifying a reference vector for the reference block, wherein the reference vector is a motion vector or a block vector;
populating a merge candidate list for the current block using the reference vector; and
encoding the current block using information from the merge candidate list.

20. A non-transitory computer-readable storage medium storing a video bitstream that is generated by a video encoding method, the video encoding method comprising:
receiving video data comprising a current picture that includes plurality of blocks, the plurality of blocks including a current block;
identifying a reference block by applying a template-matching technique to the current block;
identifying a reference vector for the reference block, wherein the reference vector is a motion vector or a block vector;
populating a merge candidate list for the current block using the reference vector; and
encoding the current block using information from the merge candidate list.
